(19) United States
(12) Patent Application Publication
(10) Pub. No.: US 2005/0162759 A1
(43) Pub. Date: Jul. 28, 2005

(54) Flat type light condensing device

(75) Inventor: Pen-Jung Lee, Chung Li City (TW)

Correspondence Address: TROXELL LAW OFFICE PLLC, SUITE 1404, 5205 LEESBURG PIKE, FALLS CHURCH, VA, 22041, US

(73) Assignee: TECO IMAGE SYSTEMS CO., LTD.

(21) Appl. No.: 10/761,331

(22) Filed: Jan. 22, 2004

(51) Int. Cl. G02B 7/02

(52) U.S. Cl. 359/819

(57) ABSTRACT

A flat type light condensing device used in an optical path device includes a hollow frame whose two ends have rectangular openings and a plurality of lenses arranged in the frame. The flat type light condensing lens is used in a scanner to reduce the occupied space in an optical path device and also facilitate the design. Moreover, only data of a single line are captured to reduce unwanted intermixing of data from other lines for enhancing the MTF of the scanner and further letting the brightness be more uniform when imaging.

### FIELD OF THE INVENTION

The present invention relates to a flat type light condensing device and, more particularly, to a light condensing lens used in a scanner or a copier to condense light reflected by a manuscript and image onto an optical-to-electric (OE) converter.

### BACKGROUND OF THE INVENTION

In a common image readout device, an optical path device (usually called an optical engine) reflects light many times. A light condensing device (usually a lens) then focuses light for imaging. Next, an optical-to-electric (OE) converter converts optical signals into electric signals to be processed and memorized by electronic devices. The OE converter commonly used in the industry today is a charge coupled device (CCD), and can also be a complementary metal-oxide semiconductor (CMOS) device. During travel of light, a certain length of optical path is required for imaging to narrow its width. Therefore, several reflecting mirrors are generally used to let the imaging width of light gradually narrow along with increase of optical path for reducing its size. Finally, the light condensing device focuses light to image onto the OE converter.

As shown in FIG. 1, an optical path device 1 comprises a light source 13, three rectangular reflecting mirrors 14, 15 and 16, a light condensing device 17 and an OE converter (e.g., a CCD 18). Light of the light source 13 penetrates a transparent glass 12 and projects to an original manuscript 14, which reflects the light to the first reflecting mirror 14, the second reflecting mirror 15 and the third reflecting mirror 16 in order. The third reflecting mirror 16 then reflects the light to the light condensing device 17, which focuses the light onto the CCD 18. The optical path device 1 is driven by a drive device (not shown) to make linear motion along a guide rod 19 for scanning the original manuscript. The above lens, however, has the following drawbacks:

1. As shown in FIG. 2, the light condensing device 17 is formed by fixing a plurality of cylindrical lenses in a shell, and thus will occupy much space in the optical path device 1, hence easily affecting the travel path of light. When the whole amount of incident light is to be enhanced, it is necessary to enlarge the diameter and length of the light condensing device 17 (a light condensing device 17′ by dashed lines).

2. As shown in FIG. 3, a CCD 18 of an image readout device is a lengthwise detector, which performs data conversion and collection in a line-to-line way. Therefore, one doesn't need light data of the whole cylindrical lens in practice. In the prior art, data of other lines may easily intermix to result in deterioration of the modulation transfer function (MTF).

3. As show in FIG. 3, because the cross section areas A1 and A2 in the vertical direction of a cylindrical lens 17 are not the same in the conventional light condensing device, light from a light source S projected onto the CCD 18 via the light condensing device 17 will be non-uniform, hence resulting in stronger light intensity at the center of the CCD 18 and weaker light intensity at two ends of the CCD 18 (shown in FIG. 4) and thus causing uneven brightness when imaging.

### SUMMARY AND OBJECTS OF THE PRESENT INVENTION

The primary object of the present invention is to provide a flat type light condensing device. The present invention mainly provides a flat type light condensing lens used in a scanner to reduce the occupied space in an optical path device and also facilitate the design. Moreover, only data of a single line are captured to reduce unwanted intermixing of data from other lines for enhancing the MTF of the scanner and further letting the brightness be more uniform when imaging.

To achieve the above object, a flat type light condensing device of the present invention comprises a hollow frame whose two ends have rectangular openings and a plurality of rectangular lenses arranged in the frame.

Another object of the present invention is to provide an optical path device comprising the above light condensing device. The structure design of the optical path device can be simplified. Moreover, the travel path of light won't be interfered, and the height can be reduced.

To achieve the above object, an optical path device of the present invention is mainly arranged in an optical equipment. The optical path device comprises a light source device, a reflecting device, a light condensing device and an OE converter. The light source device provides the required light. The reflecting device comprises at least a reflecting mirror, each reflecting the light at least once to accomplish a predetermined total track. The light condensing device receives light reflected by the reflecting device and condenses it for imaging. The light condensing device comprises a hollow frame whose two ends have rectangular openings and a plurality of lenses arranged in the frame. The OE converter receives light collected and imaged by the light condensing device and converts it into an electric signal.

The various objects and advantages of the present invention will be more readily understood from the following detailed description when read in conjunction with the appended drawings, in which:

### BRIEF DESCRIPTION OF DRAWINGS

FIG. 1 is a diagram of an optical path device of a conventional image readout device;

FIG. 2 is a diagram showing the function of a conventional light condensing device to light;

FIG. 3 is a diagram showing that a conventional light condensing device collects reflected lights onto a charge coupled device;

FIG. 4 is a coordinate diagram showing light intensity versus length of a conventional charge coupled device;

FIG. 5 is a perspective view of a light condensing device of the present invention;

FIG. 6 is a front view of a light condensing device of the present invention;

FIG. 7 is a coordinate diagram showing light intensity versus length of a charge coupled device after lights are focused by a flat type light condensing device of the present invention and onto the charge coupled device;

FIG. 8 is a perspective view of a flat type light condensing device according to a preferred embodiment of the present invention;

FIG. 9 is a perspective view of a flat type light condensing device according to another embodiment of the present invention;

FIG. 10 is a perspective view of a flat type light condensing device of the present invention assembled in an optical path device; and

FIG. 11 is a flowchart showing the manufacturing steps of a flat type light condensing device of the present invention.

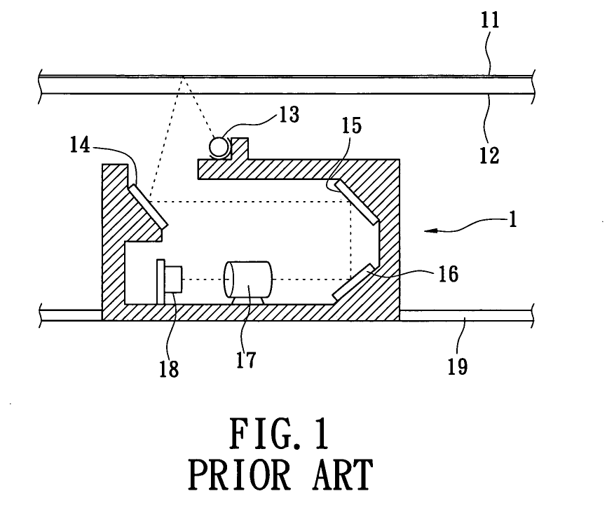

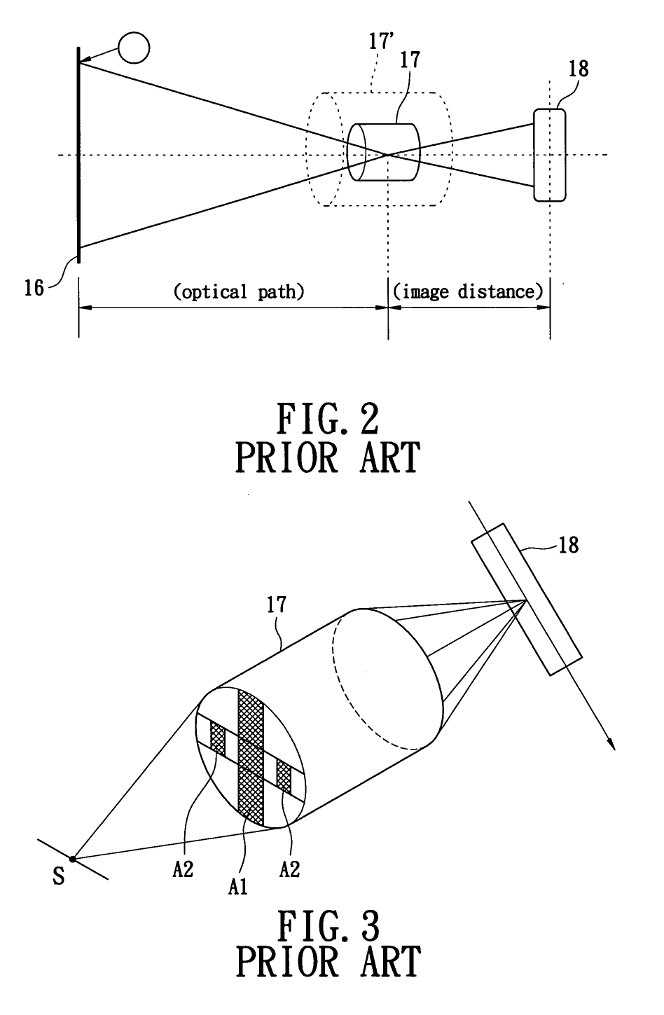

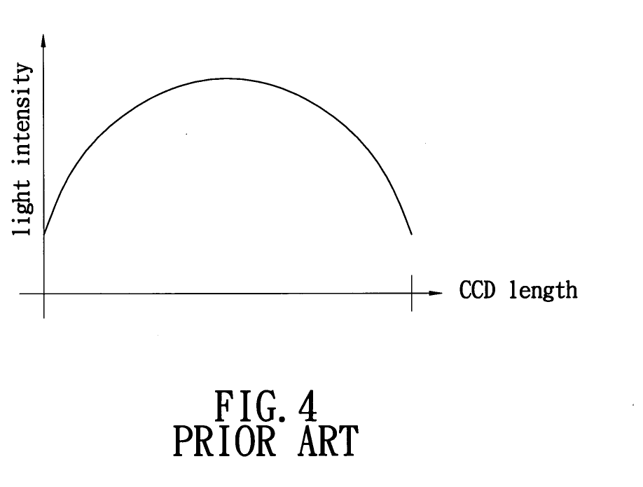

### DETAILED DESCRIPTION OF PREFERRED EMBODIMENT

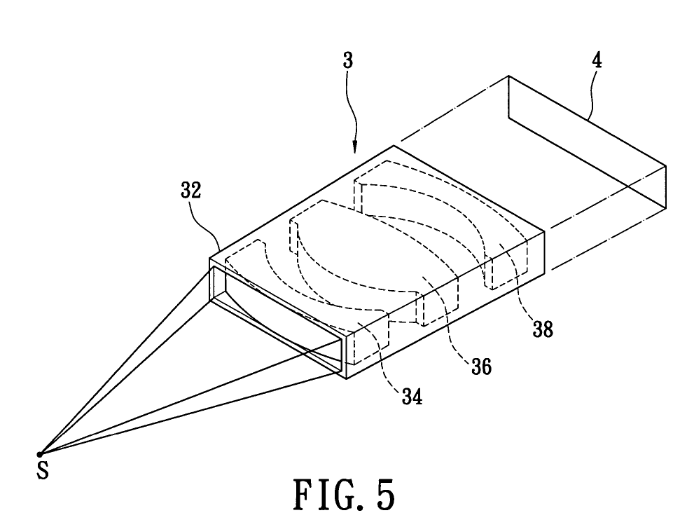

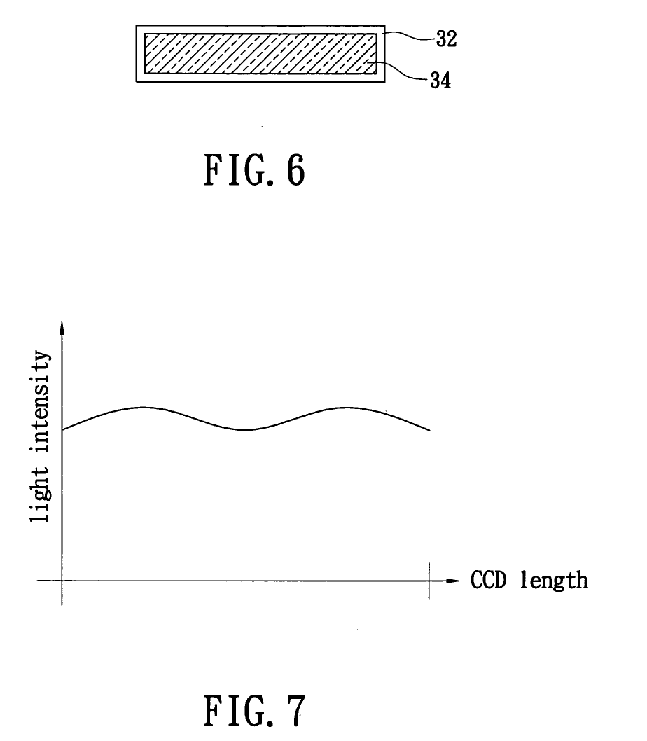

As shown in FIGS. 5 and 6, a light condensing device 3 is arranged in an optical path device of an optical equipment, e.g., an optical engine of a scanner. The flat type lens 3 has a frame 32 having a rectangular cross section. The frame 32 is a flat type shell having two rectangular openings. A lens set 30 is provided in the frame 32. The lens set 30 comprises a plurality of rectangular lenses 34, 36 and 38 for condensing light to form an image onto an OE converter 4 (e.g., a CCD). The frame 32 is made of plastic, metal or ceramic material. The lenses 34, 36 and 38 can be made by molding of cutting glass, but the cost will be high. In the present invention, it is preferred that the lenses 34, 36 and 38 be made by means of precise plastic injection molding to achieve a lower cost. The precise plastic injection molding is used in lenses of digital still cameras today and won't be further described below.

The lens set 30 at least comprises a light incidence piece 34, a light condensing piece set 36 and a light splitting piece 38. The size of the light incidence piece 34 corresponds to the scan size (e.g., A3 or A4 size) of a scanner. The size of the light splitting piece 38 corresponds to that of the OE converter 4. The light condensing piece set 36 corresponds to the light incidence piece 34 and the light splitting piece 38, and can have a different design according to the requirement of the light splitting piece 38. Because the OE converter 4 is usually fixed by a bracket, the frame 32 in the present invention can be combined with the bracket of the OE converter 4. That is, the OE converter 4 can be arranged at a distal end of the frame 32 to reduce influence from external lights. The frame 32 of the present invention can be integrally formed, and can have some lock mechanisms therein to assemble and lock the lens set 30 in the frame 32. Some adhesives can also be added for fixation.

Please refer to FIG. 7 simultaneously. When the reflected light passes the flat type light condensing device having a uniform cross section, a light intensity curve with a smaller fluctuation can be obtained to reduce stray light (i.e., mixture of data from other lines). Therefore, incidence of unnecessary lights can be reduced to effectively enhance its MTF.

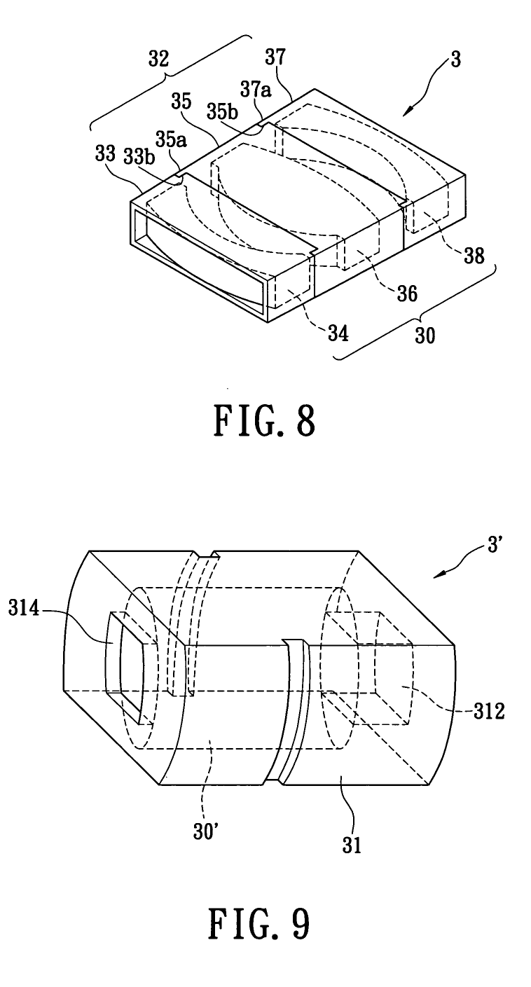

As shown in FIG. 8, the frame 32 is made of metal or ceramic material, and comprises a plurality of sub-frames 33, 35 and 37. The lenses 34, 36 and 38 can be formed on the corresponding sub-frames 33, 35 and 37, respectively. The sub-frames 33, 35 and 37 are made of stainless steel or ceramic material. Two ends of the sub-frames 33, 35 and 37 form lock portions 33a, 35a and 37a to connect the sub-frames 33, 35 and 37 together. Because the lenses are directly formed and fixed on the refractory material like stainless steel or ceramic, they won't be easily affected by temperature to deform. Moreover, the present invention can be assembled quickly. Besides, the OE converter 4 can also be arranged on the same sub-frames to quicken the assembly.

As shown in FIG. 9, in a flat type light condensing device 3′ of the present invention, a circular lens set 30′ can be arranged in a flat type frame 31, whose two end openings are a light incidence region 312 and a light escape region 314 of a slightly rectangular shape, respectively, for shielding unnecessary lights. Because the circular lens set 30′ is convenient to manufacture and obtain, it is only necessary to manufacture the flat type frame 31 for effectively reducing the height of the light condensing device.

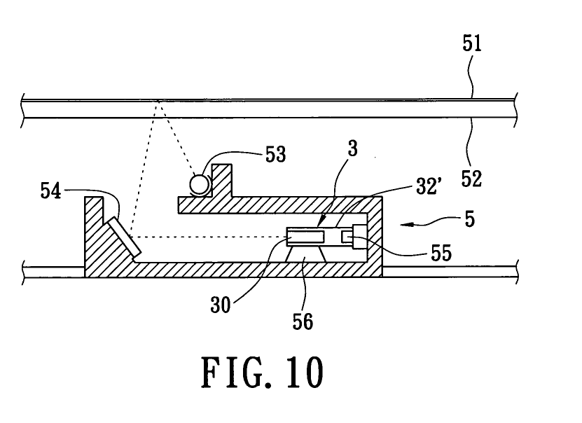

As shown in FIG. 10, an optical path device 5 is mainly arranged in an image readout device like a scanner or a multifunction printer. The optical path device 5 comprises a light source device 53, a reflecting device, a fixing device 56 and an OE converter 55. The light source device 53 is used to provide the required light. The reflecting device comprises at least a reflecting mirror 54, and reflects the light at least to accomplish a predetermined optical path length. The fixing device 56 is used to fix the light condensing device 3 in the optical path device 5. The OE device 55 receives light collected and imaged by the light condensing device 3 and converts it into an electric signal. The light condensing device 3 receives light reflected by the light reflecting device 54 for light condensing and imaging, and comprises a hollow frame 32′ having a flat type rectangular cross section and a rectangular lens set 30 arranged in the frame 32′. The OE converter 55 can be arranged in the frame 32′ of the light condensing device 3.

It should be noted that only a reflecting mirror is provided in this present invention. This is because that the light condensing device is flat type so that the optical path won't be interfered in the structure design of the optical path device, hence having less restriction in width. Through increase of the width at the front end of the light condensing device as a wide angle design for higher light incidence, the total track can be decreased. Once the total track is shortened, the number of times of reflection of the reflecting mirror can be reduced, hence lowering the number of the reflecting mirror. Therefore, it is feasible to only provide a reflecting mirror to simplify the structure.

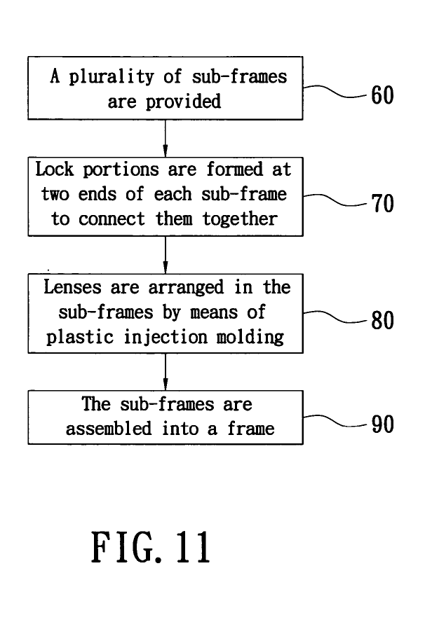

As shown in FIG. 11, the manufacturing flowchart of the flat type light condensing device comprises the following steps:

Step 60: A plurality of sub-frames are provided.

Step 70: Lock portions are formed at two ends of each sub-frame to connect them together.

Step 80: Lenses are arranged in the sub-frames by means of plastic injection molding.

Step 90: The sub-frames are assembled into a frame.

In the above manufacturing flowchart of the flat type light condensing device, a sub-frame is further provided at the distal end of the light condensing device to accommodate an OE converter.

To sum up, the present invention has the following characteristics and functions:
1. The design of a flat type light condensing device is adopted to reduce the interference region of optical path and also lower the height of an optical path device.
2. Because a flat type local lens is adopted, stray light can be reduced relative to the peak region of image to enhance the MTF.
3. Because a flat type design is adopted, there is less restriction in width, and a wide angle design for higher light incidence can be accomplished.
4. Because a wide angle design for higher light incidence is adopted, the total track can be decreased. Once the total track is shortened, the number of times of reflection of the reflecting mirror can be reduced, hence lowering the number of the reflecting mirror and also the cost.
5. Because the total track is shortened, the number of the reflecting mirror is decreased, and the incident brightness is increased, the MTF can thus be enhanced, and the requirement for assembly accuracy can also be lowered.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A flat type light condensing device arranged in an optical path device of an image readout said device comprising:
a) a hollow frame having a rectangular cross-sectional configuration first and second rectangular openings located on opposing ends thereof, the first rectangular opening receiving a light and the second rectangular opening discharging a condensed and imaged light; and
b) a plurality of lenses located within the hollow frame between the openings at opposite ends, the plurality of lenses having cross-sectional dimensions at least equal to corresponding dimensions of the first and second rectangular openings.

2. The flat type light condensing device as claimed in claim 1, wherein said frame is integrally formed of a material selected from a group consisting of plastic, metal and ceramic material, and said plurality of lenses are rectangular lenses locked in said frame.

3. The flat type light condensing device as claimed in claim 1, wherein said plurality of lenses are circular, and said first and second rectangular openings at two ends of said frame comprise a rectangular light incidence region and a rectangular light escape region, respectively.

4. The flat type light condensing device as claimed in claim 1, wherein said frame comprises a plurality of rectangular sub-frames made of one of metal and ceramic, and lock portions are formed at ends of each of said sub-frames to connect them together.

5. The flat type light condensing device as claimed in claim 4, wherein said lenses are rectangular lenses made of plastic material, and are formed in corresponding sub-frames to prevent the lenses from deforming due to temperature.

6. The flat type light condensing device as claimed in claim 1, wherein said lenses comprises a light incidence piece, a light condensing piece set and a light splitting piece, said light incidence piece has a size corresponding to a scan size of a scanner, said light splitting piece has a size corresponding to that of a charge coupled device, and said light condensing piece set is composed of more than one lens.

7. The flat type light condensing device as claimed in claim 1, wherein a charge coupled device is assembled in said frame.

8. An optical path device for optical equipment, said optical path device comprising:
a) a light source device providing light;
b) a reflecting device comprising at least a reflecting mirror, each said reflecting mirror reflecting said light at least once to accomplish a predetermined total track;
c) a light condensing device receiving light reflected by said reflecting device and condensing it for imaging, said light condensing device comprising a plurality of lenses mounted in a hollow frame having first and second rectangular openings located on opposing ends thereof, the first rectangular opening receiving a light and the second rectangular opening discharging a condensed and imaged light, the plurality of lenses having cross-sectional dimensions at least equal to corresponding dimension of the rectangular openings; and
d) an OE converter receiving light collected and imaged by said light condensing device and converting the light into an electric signal.

9. The optical path device as claimed in claim 8, wherein said OE converter is arranged in an end of said frame of said light condensing device.

10. The optical path device as claimed in claim 8, wherein said frame is integrally formed of a material selected from a group consisting of plastic, metal and ceramic, and said plurality of lenses are rectangular lenses locked in said frame.

11. The optical path device as claimed in claim 8, wherein said frame comprises a plurality of rectangular sub-frames made of one of metal and ceramic, said lenses are rectangular lenses made of plastic material, and are formed in corresponding sub-frames, and lock portions are formed at two ends of each of said sub-frames to connect them together to prevent the lenses from deforming due to temperature.

12. The optical path device as claimed in claim 8, wherein said lenses are circular, and said first and second rectangular openings at two ends of said frame bound a rectangular light incidence region and a rectangular light escape region, respectively.

13. The optical path device as claimed in claim 8, wherein said lenses comprises a light incidence piece, a light condensing piece set and a light splitting piece, said light incidence piece has a size corresponding to a scan size of a scanner, said light splitting piece has a size corresponding to that of a charge coupled device, and said light condensing piece set is aspheric.

14. The optical path device as claimed in claim 8, wherein an end of said flat type light condensing device near said reflecting device is equal to or larger than an end of said flat type light condensing device near said OE converter.
